(19) United States
(12) Patent Application Publication
(10) Pub. No.: US 2007/0028166 A1
(43) Pub. Date: Feb. 1, 2007

(54) System and processes for dynamic document construction

(76) Inventors: Allen Hundhausen, Denver, CO (US); Don Lohse, Denver, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 10/063,317

(22) Filed: Apr. 10, 2002

(51) Int. Cl. G06F 17/00

(52) U.S. Cl. 715/530; 715/513; 715/517

(57) ABSTRACT

The present invention provides the capability for dynamically constructing layouts for documents and generating rendered versions of such documents in a variety of output formats. In a preferred embodiment of the present invention, the system of the present invention provides a specialized application server that enables a user to remotely edit content and layout of documents as well as create new content and layout.

### BACKGROUND OF INVENTION

The presentation of information has been the keystone of communication. The presentation of information in a manner that best conveys this information to a viewer is critical. Thus, it is important for document creators to arrange the information for ease of viewing, for attention-grabbing and other qualities. This can range form arranging text and graphics for newspapers, magazines, newsletters, etc. to the use of corporate information on letterheads and business cards to creating signs to designing websites.

Traditionally, desktop applications have been utilized to create documents. These desktop applications can be word-processing applications, pre-press applications, or other types of applications and/or suites of applications that allow the document creator to create and add content such as text, graphics, and other objects in a specified topographical layout. The applications to do these tasks tend to be expensive and require extensive training.

Application servers have become popular in order to reduce the cost of utilizing desktop applications. These applications, for document creation, allow a user to submit content that are inserted into pre-generated templates. Presently, these types of application servers merge content into pre-generated Hyper Text Mark-up Language templates. The user is not provided the ability to edit the layout of the content of documents created in such application servers. The content of such documents cannot be dynamically managed. The user is only able to preview the merged documents.

Thus, problems exists in allowing document creators the ability to effectively design documents with any degree of flexibility.

### SUMMARY OF INVENTION

The present invention provides the capability for dynamically constructing layouts for documents and generating rendered versions of such documents in a variety of output formats. In a preferred embodiment of the present invention, the system of the present invention provides a specialized application server that enables a user to remotely edit content and layout of documents as well as create new content and layout.

Currently available application servers merge and manipulate content that is constructed by use of HTML (Hyper Text Markup Language) based templates. The Content Management server of a preferred embodiment of the present invention can instead manipulate templates and content inside a virtual document workspace. This allows the server to take advantage of the typographical and layout features usually only available in the sophisticated pre-press desktop applications, as well as access to content stored in documents.

The document and graphics capabilities of Content Management server are based on a layout and graphics engine, such as in QuarkXPress® by Quark, Inc. When provided with automated dynamic data sources or remote user input, the Content Management server can dynamically construct a layout of a document and generate rendered versions of that document in a variety of output formats, compatible with both electronic and print workflows.

The result of this process is dynamically constructed pages in higher fidelity formats than are output from application servers on the market today. Since there is a largely functional version of the document layout/word processing application running as part of the Content Management server, the Content Management server″s capabilities are not limited to only rendering content. For example, the Content Management server could be used to supply a built in feature of the document layout engine or word-processing application such as hyphenation and justification into a client/server environment.

The main goal of Content Management server is to allow dynamic content to be rendered in ways not possible using HTML. While most application servers merge dynamic content into pre-generated HTML templates, Content Management server retains the high fidelity representation of a template and content until after the two have been merged. This allows the layout and typographical features available to QuarkXPress document to be applied to dynamic content.

These and other features are evident from the drawings and the detailed description of preferred embodiments.

### BRIEF DESCRIPTION OF DRAWINGS

FIG. 1 is a schematic illustration of a preferred embodiment of a client/server system for dynamically constructing, managing and rendering documents.

FIG. 2 is an example of an application of the embodiment of FIG. 1.

FIG. 3 is a screenshot of the application of FIG. 2.

FIG. 4 is another screenshot of the application of FIG. 2.

FIG. 5 is the preview of the application of FIG. 2.

FIG. 6 is a workflow illustration of the system of FIG. 1.

FIG. 7 is a schematic of the system of FIG. 1.

FIG. 8 is a schematic of another embodiment of the present invention.

FIG. 9 is a schematic of yet another embodiment of the present invention.

FIG. 10 is a schematic of another embodiment of the present invention.

### DETAILED DESCRIPTION

The present invention provides systems and processes for dynamically constructing content for publication and for generating rendered versions of such documents in a variety of output formats, including non-image formats. The present invention, in a preferred embodiment, provides applications acting as a prepress server, proofing server, ad server, and a development platform for custom applications. It is to be expressly understood that the exemplary preferred embodiments disclosed are for descriptive purposes and are not intended to limit the scope of the present invention. Other embodiments are within the scope of the claimed inventions.

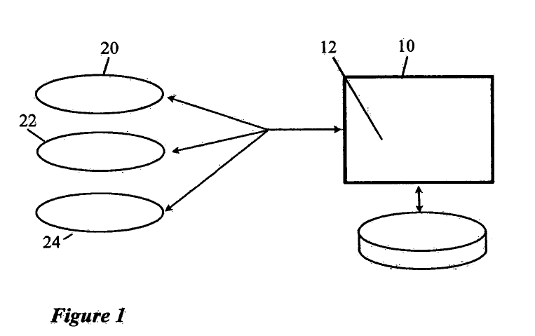

A preferred embodiment of the present invention provides a collaborative publishing tool that accepts and merges content from any user that has a browser or other client-server interface. A schematic of such an embodiment is illustrated in FIG. 1. Templates are created using a design tool, such as QuarkXPress, for a document and stored in the Document Server 30. A user is able to access the system of this preferred embodiment through a browser 20 or any other type of application that can make a server request, such as a Internet based http request. In an exemplary mode of this preferred embodiment, this request is processed by a proxy server 30. Content from the user is submitted through the proxy server to the document server 10. The submitted content is flowed into the stored templates. Documents are then rendered into specified formats. The user can then view the rendered document in the user″s browser. The document can then be edited if necessary. In the preferred embodiment, low resolution images may be used to speed the process. High resolution images of the document can be viewed as well. The final document can then be outputted in a variety of formats as desired by the user.

The templates in the document server 10 can include editing fields specified by the document designer. These editing fields can later be edited by the users on their browser. These fields can include text, images or any other type of content. The user may even publish content directly from the document server. The content may be published via print, email, webpages or any other type of publication and/or format. The proxy server 30 also handles management functions, such as load balancing, caching, document pool maintenance and other tasks.

A preferred embodiment of the present invention is schematically illustrated in FIG. 1. The document server, also known as the Content Management server 10 is networked to client browsers 20, 22, 24 through an HTTP connection 30. The Content Management server 10 is also connected to a file server 40 that maintains the content and documents utilized by the server 10. In the preferred embodiment, the Content Management server 10 includes a layout and document preparation engine 12, such as the QuarkXPress engine. This enables management of topographical and layout of content and other prepress tools, content management, color matching, trapping, and other important document prepress and publishing tools. Other features may be available, such as spelling, grammar check, hyphenation, and other useful features. In a preferred embodiment, the server engine 12 acts as a “headless”application.

The client browsers 20 24 provide the head to the application by way of a user interface. The user interface, in the preferred embodiment, enables the user to see a rendering of the document as well as input information to the server engine. This enables the user to preview documents and also input information to templates. The server engine 12 retains the high resolution representation of a template and of content. A low resolution rendering of the template and content is sent to the user browser 20 for viewing by the user. Once the document has been approved by the user, then the high resolution representation of the template and content are merged at the server engine 12. This merged representation is then rendered into one of several formats and stored in the file server 40 or sent to a print application, to the user or to other applications or storage sites.

Examples of formats that the merged template and content can be rendered into include, but are not limited to, QuarkXpress, raw QuarkXPress, Encapsulated Post Script, Post Script, SVG Export, XML import, PDF, HTML, eBooks, JPEG, PNG, and substantially all of formats presently available or that may be later developed.

The features of the server engine 12 allow a user the benefit of these features without the need to have such features resident at the user site. In one preferred embodiment, the server 10 allows documents created from existing desktop publishing applications to be stored and used as document templates. The server 1 0 allows certain fields in the templates to be designated for content input. The server then provides input screens to the browser 20 to allow the user to add appropriate content to the templates. A low resolution rendering of the high resolution representation of this content and template is then displayed at the user browser to allow the user to preview the document being created.

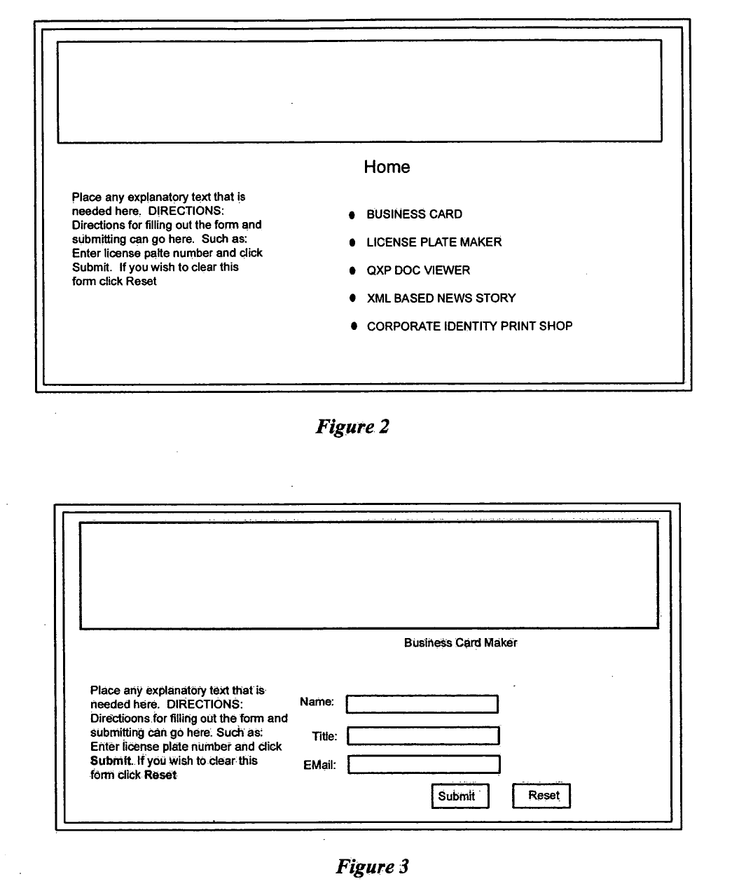

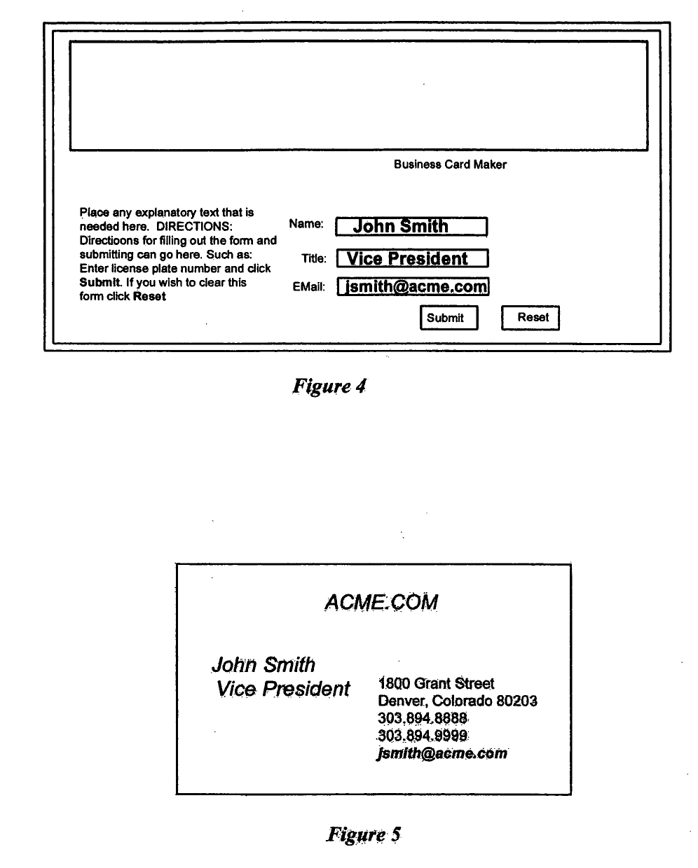

An example of this preferred embodiment is displayed in FIGS. 2 5. FIG. 2 is an illustration of a screenshot of the browser interface 100. In this example, the user has the choice of several menu items. The user may choose to create a business card, a license plate, or other document. In this example, the user desires to create a corporate business card. A high resolution document for the desired business card has been previously created on a powerful desktop publishing system, such as QuarkXPress and stored on the file server 40. This document is checked into the server 10 and the fields for the name of the user, the title of the user and the email address for the user have designated as content entry fields. All the user will see at the browser 20 is the screenshot 120, shown in FIG. 3. The user will then enter the requested information and click on the Submit button. A low resolution rendering of the high resolution representation of the template and inputted content is then previewed for the user on the browser, as shown in FIG. 4. This rendering can be in a format such as JPEG for ease of transmission and so not require proprietary or special viewing software. If the preview is satisfactory, then the server is notified, and the template and inputted content are merged to form a high resolution document. This document is then rendered into a desired format, such as a QuarkXPress document, a pdf file, an EPS or PS file or other format. The rendered file can then be submitted for printing.

In the above example, the same process can be used to create license plates, or to create a corporate identity print shop. The corporate identity print shop allows a user to have corporate documents, such as letterhead, business cards, faxes and envelopes printed on demand with the corporate identity (logo, corporate name and address and layout to simulate official corporate documents). The user is able to input the requested information, such as personal name and title, and view a low resolution rendering of the assembled document. The high resolution representation is maintained at the server 10.

In another example of a preferred embodiment, the system is used for supplying content for newspapers, magazines, newsletters, journals, e-zines and other types of periodicals. The fields are predefined, for example, headline, byline, captions, photographs, diagrams and main body. The content is supplied by the author who is also able to view the rendered page prior to publication. Many other types of documents can be created in a similar manner. Also, the document may be previewed, edited or otherwise viewed by other users.

Another useful feature shown in the example is the ability to view renderings of other formats. For instance, the present invention enables a user to request a particular document or template that is in a particular format such as QuarkXPress or EPS. Normally this would require the user to have a copy of QuarkXPress installed on their local computer, or other software to enable viewing of the particular format. However, the preferred embodiment of the present invention enables a user to request a document regardless of the document format. The server engine then pulls the document and sends a low resolution image of the rendered document to the browser of the user. The user is then able to view the document without the need of any software other than a typical browser capable of viewing JPEG or other image files.

Another unique feature provided by a preferred embodiment of the present invention is the ability to provide viewing with a standard web browser or other image viewing device of documents that include complex structures and true creative design intent. For example, even though documents prepared for print purposes are often rich in design and complexity, most web pages are simply text boxes and image boxes. The preferred embodiment of the present invention enables a document that is rich in design intent to be rendered into a low resolution image format, such as JPEG, and then transmitted as the web page. This allows overlapping content objects, such as text, images, lines, artwork, etc. to be displayed. Additionally, the same document will be displayed in the same way regardless of the particulars of the web browser or viewer. Previously, due to faults with different versions of browsers or ability to view HTML documents, different browsers would view the same document in different ways.

In another preferred embodiment, the present invention enables an XML (extensible Markup Language) document to be checked in as a layout document that is then converted into a template as discussed above. The template from the XML document is then able to be used to add content and then rendered for preview purposes. The high resolution representation of the template and content can then be rendered into a desired format.

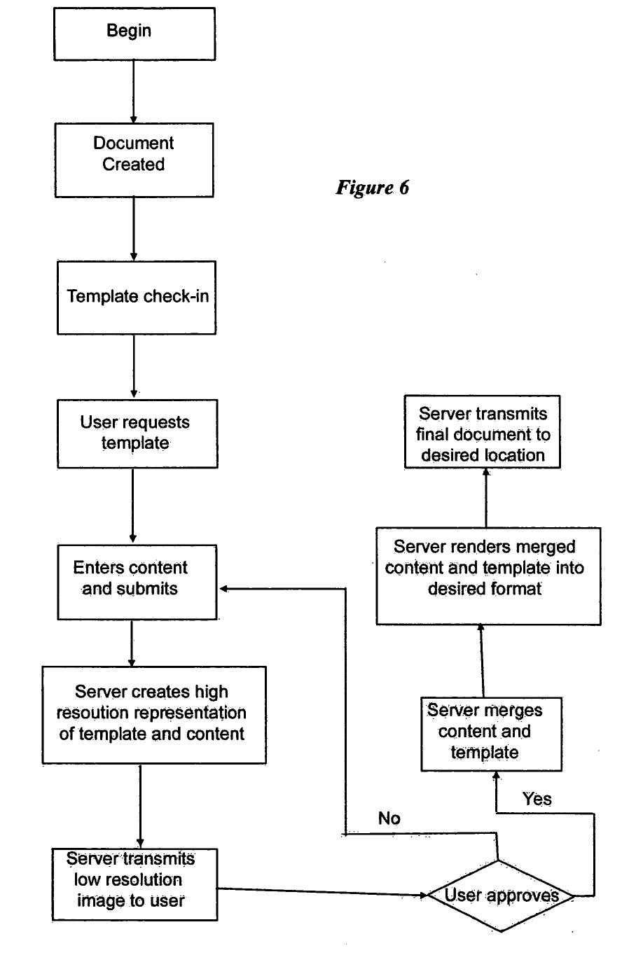

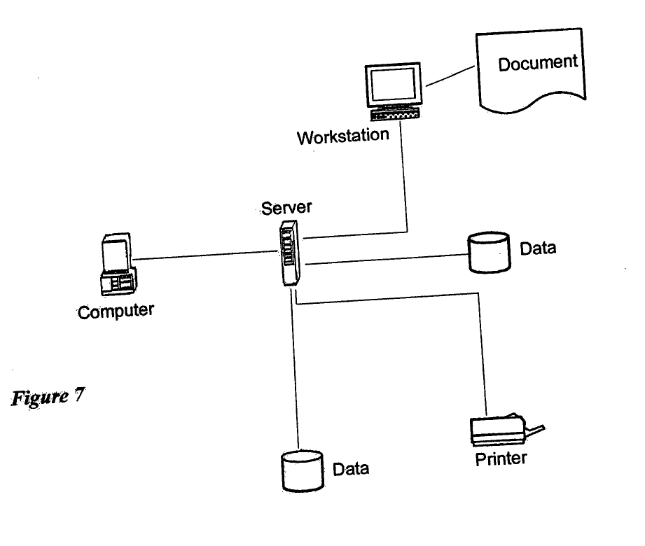

The workflow of the preferred embodiment of the present invention is displayed in FIG. 6 and schematically in FIG. 7. A document is created using a desktop publishing program, such as QuarkXPress. This document can include artwork, images, text or other desired content. The content is arranged topographically along with other desktop publishing functions with the full design intent of the document designer. Content fields can be designated for input from later users. This created document is then “checked-in” to the server as a template. Also, at this time the content fields can be created. A user at a browser can then select the desired document template. The user then inputs the requested content and submits it to the server. The server then creates a high resolution representation of the content and the template and sends a low resolution rendering of this representation to the user for preview purposes. Once the user approves the document preview, then the server merges the content and template and renders it into a desired format. This rendered file can then be stored, transmitted, printed, or otherwise utilized.

In another preferred embodiment, the user is able to use certain commands to change the document template at the server. For example, the user may be able to change the topographical layout, make typographical changes, adjust colors, etc. to the template without having the engine resident on their local site. Low resolution images of the adjusted document and/or content can then be viewed. The high resolution representations of these changes are maintained at the server until the decision is made to merge the document and content and render them to a desired format.

In another preferred embodiment, the server 10 may not maintain the high resolution representation directly at the server. Instead, the server 10 pulls a low resolution version of high resolution images that are located in a database or storage elsewhere. Then, once the document and content has been approved, the high resolution image is merged into the document and rendered into the final format.

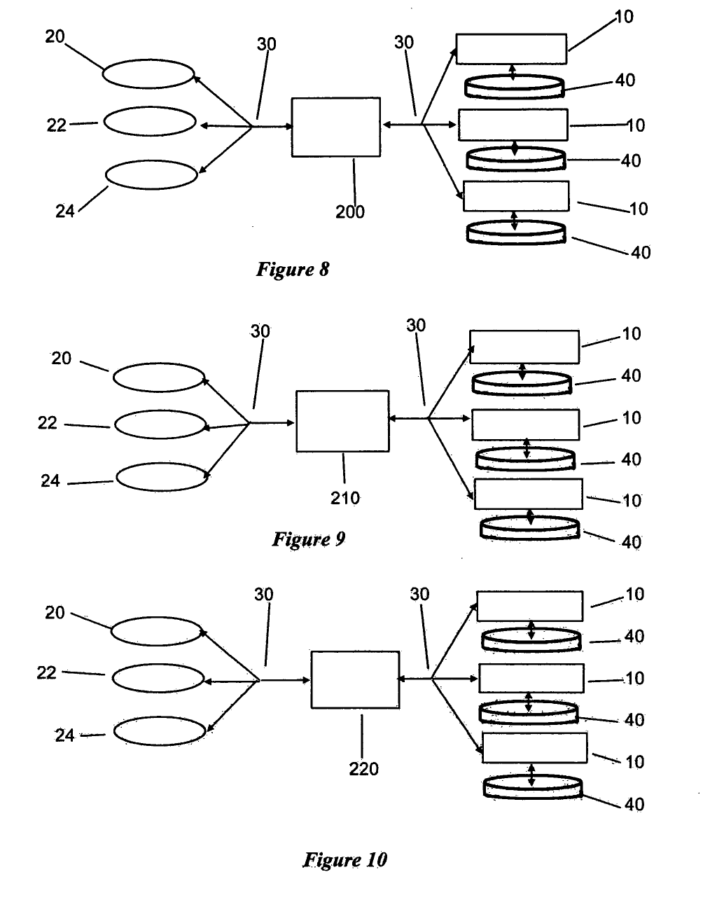

In another preferred embodiment of the present invention shown schematically in FIG. 8, the server 10 can be load-balanced and used from an application server 200. The user is never aware of the server 10. The user is networked to the application server 200 that then calls on the server 10 as necessary to perform the desired tasks. For example, the application server 200 may be the business card application that is available over the Internet. The user only directly connects to the application server 200. The application server 200 then makes the necessary calls on the server 10 for the appropriate functions.

Also, in another preferred embodiment, shown schematically in FIG. 9, a caching proxy 210 is maintained between the browsers 20 24 and the server 10. This will allow the server 10 to be scaled accordingly and improve the efficiency of the process. Also, as shown in FIG. 10, the server 10 can be maintained behind a secure web server for security purposes.

Additional preferred embodiments enable the use of Xtension applications to add to the functionality of the content management server.

It is to be expressly understood that the exemplary preferred embodiments are intended for descriptive purposes only and are not meant to limit the scope of the appended claims.

1. A method for dynamically constructing a document on a client server system having pre-defined templates, said method comprising the steps of:
providing content to the pre-defined templates through a client interface to construct a document;
transmitting an image of said constructed document to said client interface for viewing; and
merging said templates and said content into a desired format.

1.2. The method of claim 1 wherein said method further comprises:
creating pre-defined templates by creating a document;
checking said created document into the system server; and
providing content entry fields in said created document.

3. The method of claim 1 wherein said step of transmitting an image of said constructed document to said client interface for viewing includes:
transmitting a low resolution image to said client interface.

4. The method of claim 1 wherein said step of transmitting an image of said constructed document to said client interface for viewing includes:
maintaining a high resolution representation of said template and said content at said server.

5. The method of claim 1 wherein said step of transmitting an image of said constructed document to said client interface for viewing includes:
maintaining a high resolution representation of said template and said content at said server; and
transmitting a low resolution image of said representation to said client interface.

6. The method of claim 1 wherein said method further comprises the steps of:
saving said constructed document in a variety of formats.

7. The method of claim 1 wherein said method further comprises the steps of:
publishing said constructed document from the server.

8. A method for dynamically construct a document on a client server system, said method comprising the steps of:
creating a document;
checking the document into a server as a template;
providing content entry fields in said template;
providing a client interface to add content to said content entry fields;
maintaining a high resolution representation of said template and said content at said server;
transmitting a low resolution image of said representation to said client interface; and
merging said template and said content into a desired format.

9. The method of claim 1 wherein said method further comprises the steps of:
saving said constructed document in a variety of formats.

10. The method of claim 1 wherein said method further comprises the steps of:
publishing said constructed document from the server.

11. A system for constructing a document through a client server network, said system comprising:
a document management application residing on the server;
said document management application including a document creation program for allowing a selected user to create a document having content entry fields and to check the documents into a template storage module to create a document template;
a client interface to allow users to add content to said document templates;
a rendering engine that renders images of said content added to said document template in a representation of said constructed document for viewing on said client interface; and
a system for merging said content and said document template into a selected format.

12. The system of claim 11 wherein said system further includes:
a module for maintaining a high resolution representation of said content and said document template at the server.

13. The system of claim 11 wherein said system further includes:
a module for transmitting a low resolution representations of said content and said document template to said client interface.

14. The system of claim 11 wherein said system further includes:
a module for maintaining a high resolution representation of said content and said document template at the server; and
a module for transmitting a low resolution representation of said content and said document template to said client interface.

15. The system of claim 11 wherein said system further includes:
a module for publishing said constructed document from said server.

16. The system of claim 11 wherein system further includes:
a module for publishing said constructed document from said server in a variety of formats.

17. The system of claim 11 wherein the system further includes:
a module for merging said document template and said content in a variety of formats.
